(19) United States
(12) Patent Application Publication
(10) Pub. No.: US 2005/0038822 A1
(43) Pub. Date: Feb. 17, 2005

(54) Method, device for adapting digital files

(75) Inventors: Nicolas Bijaoui, Nice (FR); Vincent Coquel, Nice (FR); Loic Pierlot, Nice (FR)

Correspondence Address: YOUNG & THOMPSON, 745 SOUTH 23RD STREET, 2ND FLOOR, ARLINGTON, VA, 22202, US

(73) Assignee: Amadeus S.A.S., Biot (FR)

(21) Appl. No.: 10/497,902

(22) PCT Filed: Dec. 3, 2002
(86) PCT No.: PCT/FR02/04139

(30) Foreign Application Priority Data
Dec. 7, 2001 (FR) 01/15809

(51) Int. Cl. G06F 17/30

(52) U.S. Cl. 707/200

(57) ABSTRACT

Process and a device for adapting digital files consisting in referencing character strings to be adapted in a source file and in replacing the sources that consist of character strings by substitution data. Each source presence in the source file is referenced in a particular way by defining targets by: 1° division of the source file into sections identified by a unique section identifier; 2° selection of a source in a section; 3° selection of a context zone including the selected source; 4° assignment of an occurrence rank, in the section, to the selected context zone; 5° assignment of an occurrence rank, in the selected context zone, to the selected source, the section identifier, the selected source and its occurrence rank, the selected context zone and its occurrence rank constituting the attributes of each target.

This invention relates to a process and a device for adapting digital files consisting in referencing so-called source character strings in a file to be adapted, so-called source file, and in replacing the sources by substitution data called substitutes.

The invention will find its application in all fields where it is necessary to define in a unique and unambiguous way characters or character strings in a digital document.

The field of application relates particularly but not exclusively to the applications that are accessible by Internet for the translation of text zones from an original language to another language.

More generally, the invention may be useful in any computer application where it is desired to carry out an adaptation without altering the source document.

The term adaptation here in particular means translation (replacement of words or groups of words by their translation into another language), but also any modifications of form (size, style, screen presentation).

The production of digital documents (files, applications) is increasingly vast.

Most of the developments are made in the English language.

For users of a different maternal language, it is more practical yet to use computer products that are adapted to their own language.

Likewise, according to the desires of different users, it is useful to be able to adapt the general presentation of the programs and files.

This is particularly the case in the applications that are accessible by Internet for which various web pages can be displayed by users of very varied origins and maternal languages.

To meet these needs, without thereby multiplying the number of versions of digital documents to be produced individually, it was already thought to run adaptations of a source version (or of the origin) according to criteria of language or form.

Within this framework, it seems necessary to identify unambiguously and therefore uniquely the character strings to be adapted in the source document.

A first solution that is proposed according to the prior art is to extract character strings that depend on versions (for example on each language to be used) to additional files for storage of these resources.

According to the desired version, the data that are obtained from the corresponding resource file are loaded.

A problem that is inherent to this technique is that it must distinguish in each digital document to be adapted the dependent and independent portions of the versions.

In addition to this distinction that is internal to the digital document to be adapted, it is necessary to manage additional resource files.

It was also thought to run a referencing of data to be adapted in the source document to identify them.

These references, however, can impede the compilation or the interpretation of the digital document and can be altered by future modifications of the sources.

There therefore exists a significant need in the non-invasive identification of digital data to be adapted in a digital document without ambiguity for any type of digital document.

A first object of the invention is to define unambiguously character strings in a digital document for the purpose of a subsequent processing.

Another object of the invention is to carry out a definition of character strings to be adapted in the digital document without giving rise to modifications that can alter the validity of the document.

According to a variant, the invention also has the advantage of making possible a replacement of data facilitated with multiple adaptations that are made possible without alteration of the translation. In particular, it is possible to take into account different languages for the same adaptation, for example for a translation of English into Quebec French by taking into account data of the French language.

Another advantage of the invention is its low sensitivity to subsequent modifications of the source file.

Other objects and advantages will come out during the following description that exhibits a preferred embodiment of the invention that is not, however, limiting.

This invention relates to a process for adaptation of digital files consisting in referencing so-called source character strings in a file to be adapted, a so-called source file, and in replacing the sources by substitution data called substitutes, characterized by the fact that each source presence is referenced in the source file by defining a target by:

1° division of the source file into sections identified by a section identifier;

2° selection of a source in a section;

3° selection of a context zone including the selected source;

4° assignment of an occurrence rank, in a predetermined portion of the source file, to the selected source;

the section identifier, the selected source and its occurrence rank, whereby the selected context zone constitutes attributes of each target.

According to preferred variants, this process is such that:
The predetermined portion of the source file is the selected context zone, and an occurrence rank, in the section, is assigned to the selected context zone.
A unique identifier is associated with each defined target, and the definition attributes of the targets and the identifiers are stored in a model file.
At least one set of substitution data containing the substitutes of sources is created, and the targets and the substitutes are associated by the identifier.
The sources of the source file are replaced by:

1° location of each target by calculation of its position in the source file;

2° loading of a set of substitution data;

3° extraction of substitutes from the set of substitution data by
running through the substitutes and, for each, searching for the associated target,
storage of substitutes for which an associated target exists by classifying them by positional order of the associated target in the source file.
Several sets of substitution data are used;
A priority order is assigned to each set of substitution data;
Steps of loading the set of substitution data and extracting substitutes successively for each set of substitution data by decreasing order of priority are carried out.
The targets are replaced by their substitutes by decreasing order of position in the source file.
The precision of the definition of targets of a source file is verified by:
   comparison, for each target, of its attributes with the contents of the source file,
   exclusion of targets for which no source corresponding to the source attribute of the target was found in the source file;
   if at least one source corresponding to the source attribute of the target is found without the other attributes of the target corresponding to it, said source is stored for subsequent individual processing.

The invention also relates to a device that can implement the process.

The attached drawings are provided by way of example and are not limiting of the invention. They represent only one embodiment of the invention and will make it possible to easily understand it.

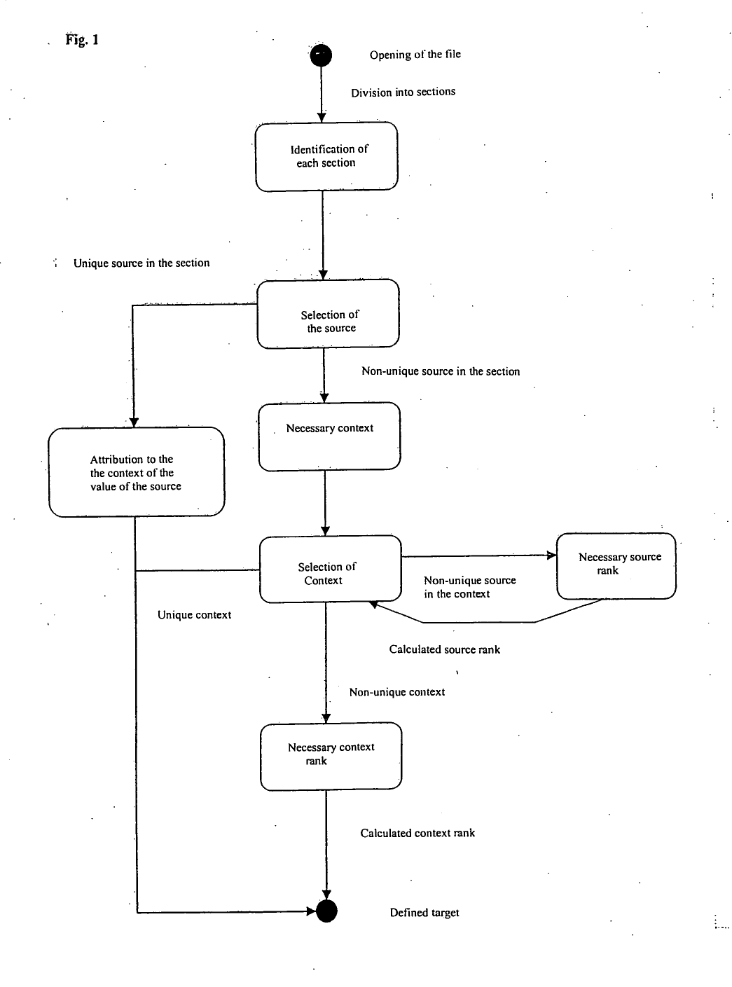

FIG. 1 illustrates phases of the process according to the invention for the definition of targets in a digital document.

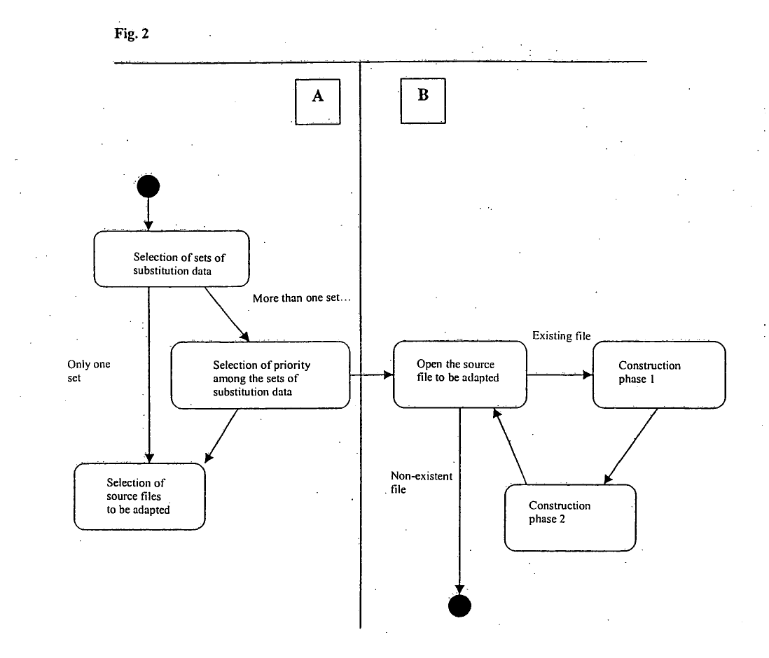

FIG. 2 shows a preliminary phase for the substitution of source character strings by substitution strings.

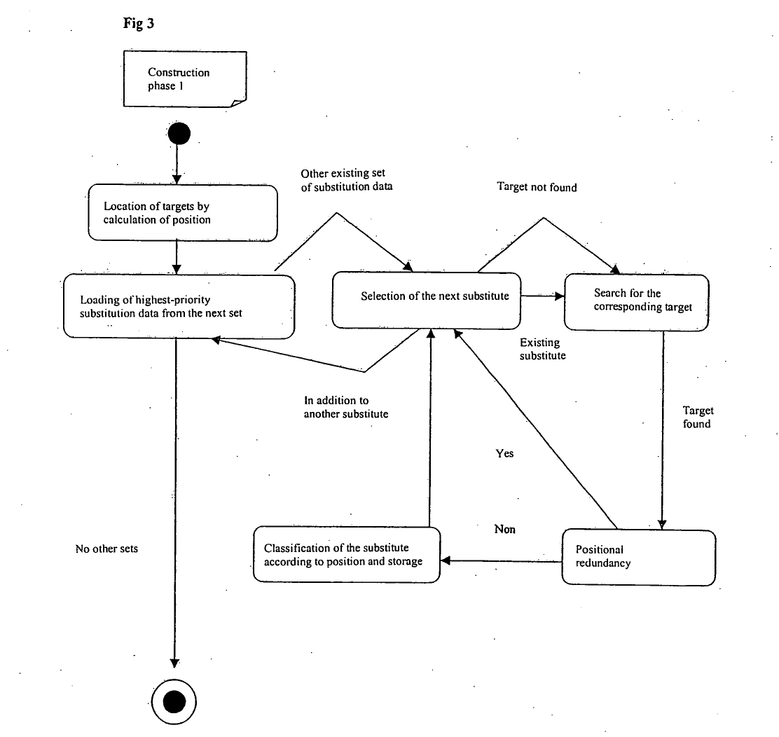

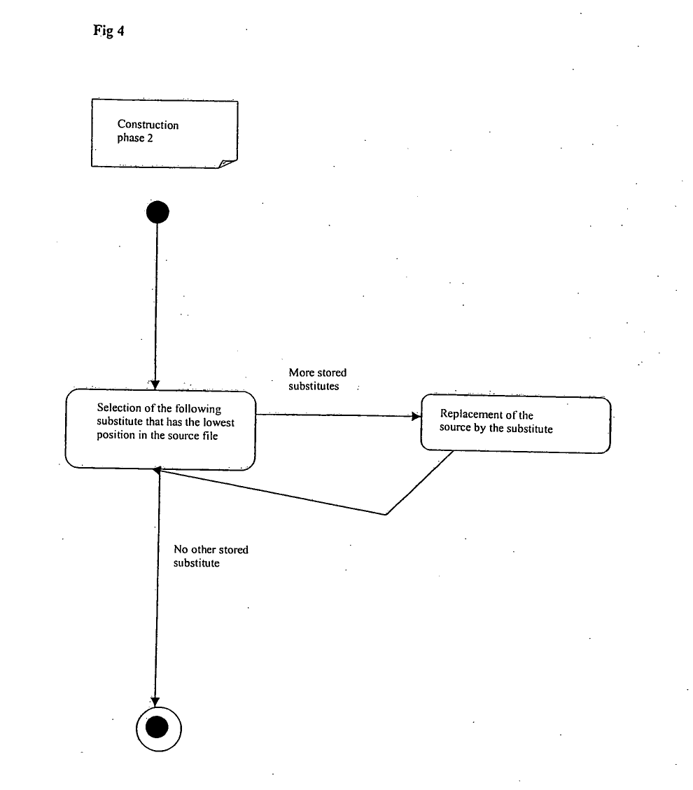

FIGS. 3 and 4 show two phases of successive construction of an adapted file by substitution of sources, in relation with FIG. 2.

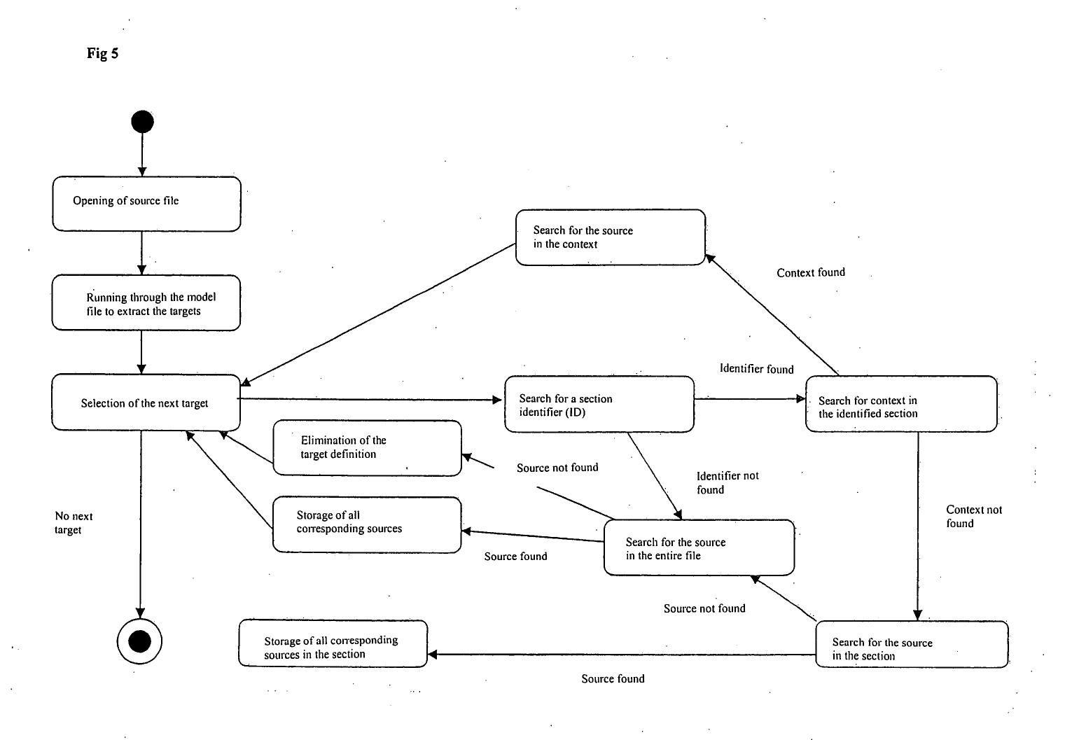

FIG. 5 illustrates an additional possibility of verification of the precision of the defined model of targets.

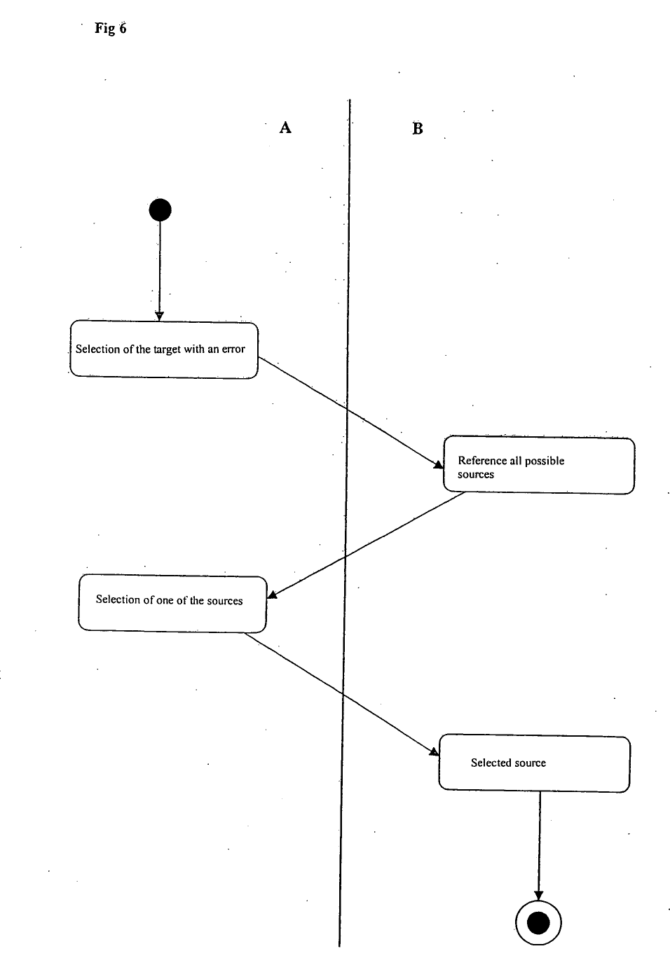

FIG. 6 shows, consecutively to the verification of FIG. 5, a possibility for correction of the document.

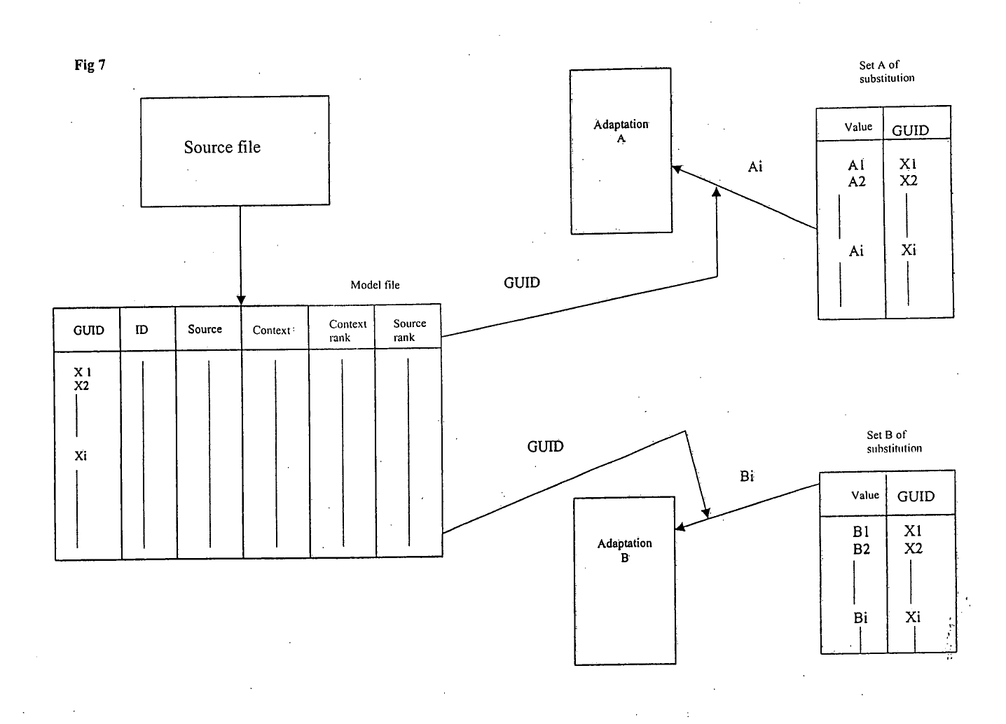

FIG. 7 diagrammatically shows the various digital data that are stored and used for the implementation of the invention.

The process according to the invention can be used by a computer-type device with means currently used in the field being considered.

In particular, the computer-type device can consist of a computer that comprises a central unit that is provided with a processor and means for memorization of digital data, means for acquisition of data and checking as well as a display monitor.

The adaptation process that is presented here comprises in particular a step of unambiguous definition of targets in the digital file to be adapted, each target integrating a character string that is called source below, to be adapted.

It should be noted that these target definition steps can be used for applications other than the adaptation of digital files.

To carry out this unambiguous definition of targets for the referencing of sources in the file to be adapted, successive operating steps are used.

To each target are assigned different attributes making it possible to define it unambiguously. These attributes are a section identifier (ID), the selected source and its occurrence rank, the selected context zone and its occurrence rank. Below, the process steps for definition of these different attributes are described.

The first step is to divide the source file into sections, whereby each section is identified by a section identifier (ID). This division is run in one or more sections.

In the example of Javascript programming, the division into sections can correspond to that of each function, and the name of the function will be attributed by way of section identifier.

A selection of sources in a section is then carried out.

This selection can be run by a user, in particular a user that is responsible for creating the model of targets to be adapted.

The character string that corresponds to the desired source within the section is thus selected.

As indicated in FIG. 1, two cases can be present at this level.

On the one hand, it is possible that the source is unique in the section that is being considered, in which case a selection of context zone corresponding to the value of the source is carried out.

In the case where the source is not unique in the section, the selection of a zone of broader context than the source makes it possible to specify the definition of the target. In some cases (and the most often possible), this detailing of the definition is adequate to lift any ambiguity of identification of the target.

To complete the definition of the target without this thereby being necessary systematically to each definition of targets, occurrence ranks are assigned to sources and to contexts.

The occurrence rank of the source is determined in a predetermined portion of the source file. This portion can be the entire file, a section or else, preferably, a context zone.

In this latter case, an occurrence rank is assigned within the section being considered to the selected context zone.

An occurrence rank, in the selected context zone, is also assigned to the selected source.

These stages are synoptically incorporated in FIG. 1.

Below, several examples that correspond to different cases of definition of targets are provided according to the uniqueness or the multiplicity of sources and context zones in the section being considered.

The examples below are provided for a Javascript programming, and the section identifier is defined in the form of the name of the function. The selected context is framed, and the selected source is underlined.

Of course, this example does not limit the definition of targets.

### EXAMPLE 1

### Case of a Unique Source in the Section

Function myFunc ( ) {
...
var html =
‘ <td align=”center” > city </td>’
‘+<td align=”center” > country </td> ‘
‘+<td align=”center” > country </td> ‘
...
}

| | | | Occurrence | |
|---|---|---|---|---|
| | | | Rank of the | Occurrence |
| | | | Context/Total | Rank of the |
| Section | | | Occurrence of | Source in the |
| Identifier | Source | Context Zone | the Context | Context |
| myFunc | City | city | 1/1 | 1 |

### EXAMPLE 2

### Non-Unique Source and Unique Context Zone in the Section

function myFunc ( ) {
...
var html =
‘ <td align=”[center” > city] </td>’
‘+<td align=”center” > country </td> ‘
‘+<td align=”center” > country </td> ‘
...
}

| | | | Occurrence | |
|---|---|---|---|---|
| | | | Rank of the | Occurrence |
| | | | Context/Total | Rank of the |
| Section | | | Occurrence of | Source in the |
| Identifier | Source | Context Zone | the Context | Context |
| myFunc | center | center” > city | 1/1 | 1 |

### EXAMPLE 3

### Non-Unique Source and Context Zone in the Section

function myFunc ( ) {
...
var html =
‘ <td align=”center” > city </td>’
[‘+<td align=”center” > country </td> ‘]
‘+<td align=”center” > country </td> ‘
...
}

| | | | Occurrence | |
|---|---|---|---|---|
| | | | Rank of the | Occurrence |
| | | | Context/Total | Rank of the |
| Section | | | Occurrence of | Source in the |
| Identifier | Source | Context Zone | the Context | Context |
| myFunc | Country | ‘+<td | 1/2 | 1 |
| | | align=“center” | | |
| | | >country</td>’ | | |

### EXAMPLE 4

### Non-Unique Source in the Selected Context Zone

function myFunc ( ) {
...
var html =
...
‘+<td class=”field” align=“center” > field 1 </td> ‘
‘+<td [class=”field” align=“center” > field 2] </td> ‘
...
}

| | | | Occurrence | |
|---|---|---|---|---|
| | | | Rank of the | Occurrence |
| | | | Context/Total | Rank of the |
| Section | | | Occurrence of | Source in the |
| Identifier | Source | Context Zone | the Context | Context |
| myFunc | field | class=“field” | 1/1 | 2 |
| | | align=“center” | | |
| | | > field 2 | | |

It is noted that this definition method systematically makes it possible to obtain a unique and unambiguous definition of sources within the digital document.

In some cases, certain attributes of the target are not necessary to an unambiguous definition and will then be filled in by default or not used.

This method of definition is implemented in particular according to the invention to carry out an adaptation of digital documents.

Within this framework, a model file is created that is shown in particular in FIG. 7 in which a unique identifier (called GUID in reference to the figures) is attributed to each target.

Stored in the model file are the definition attributes of each target and their identifier as is shown.

This model file later makes it possible to carry out all the operations and combines all the information necessary to the definition of the sources indicated in the source file.

Within the framework of an adaptation of digital files, at least one set of substitution data containing the substitutes of sources to be taken into consideration is created.

This or these set(s) of substitution data are stored separately in the data base of the device.

They are shown by the tables titled SET A and SET B in FIG. 7.

It is also seen there that the GUID identifier is associated with each value of substitute A1, A2, Ai so as to establish a correspondence between each target of the model file and the associated value of the substitution set.

It is then possible to carry out the substitution itself of the sources of the digital file by the substitutes that are contained in the sets of substitution data.

To do this, in reference to FIGS. 3 and 4, the first step is to locate the targets in the source file by calculation of their position.

In particular, a referencing of offsets will be used to establish a position of source character strings in the digital file.

Once the coordinates of each source are thus established, a loading of the set of substitution data to be used is carried out.

Below, the possibility of carrying out a multiple adaptation, i.e., using several sets of substitution data, will be studied more particularly.

Once a set of substitution data is loaded, the substitutes are extracted from said set to be used by the following operations.

In reference to FIG. 3, the first step is made by passing through the different substitutes and in searching for each of them if a target is associated with them.

If this is the case, the substitute is classified according to the offset position of the source in the digital file, and this information is stored.

First, possible positional redundancies are verified so as to ensure that the source that corresponds to this substitute was not already taken into consideration.

Once the different substitutes have been inspected, a temporary storage of different substitutes to be used for the adaptation of the source file was obtained, and the position of the sources to be adapted with these substitutes is known in correspondence.

It is then possible to replace each source that is present in the source file by its substitute as defined above, by decreasing positional order in the source file.

The decreasing order that is thus used has the advantage of not modifying the calculations of offsets carried out in advance for the data that are present further up in the source file.

It will be noted that this step of replacement by decreasing order of offset can be run with other principles of definition of targets and another operating mode for creation of sets of substitutes.

As indicated above, it is possible to carry out the multiple adaptation, i.e., to take into account at least two sets of substitution data to carry out the adaptation.

It thus will be possible, among the sets of substitution data, to define a priority set for which, if the substitution data are present, their value will be used for the adaptation of the source file.

If there is no substitute in the sources of the source file to be adapted that is present in the set of priority substitution data, a substitution is then carried out by using sets of substitution data of lower priority.

This step is shown in particular in FIG. 2 in which a selection of sets of substitution data to be used for the adaptation being considered is carried out.

If more than one set is selected, the user is induced to select an order of priority among these different sets of substitution data.

The construction phases of the adaptation file are then run corresponding to the steps described above, particularly with references to FIGS. 3 and 4.

Once these steps are carried out with the first substitution set (the one that has the highest degree of priority), the operation is successively renewed with the other sets of substitution by decreasing order of their priority.

Once the different sets of substitution have been used, the adaptation is terminated.

According to another variant of the invention, it is possible to verify the precision of the definition of targets that are present in the model file relative to the source file.

It is possible in particular, according to this possibility, to verify the accuracy of the data that are present in the model file, for example if the source file has been modified.

This verification is carried out as shown in FIG. 5 by comparison, for each target, of its attributes as contained in the model file with the contents of the source file.

The different possibilities are taken into account in the block diagram of FIG. 5.

The comparison begins by the search for the section identifier (ID) that is attributed to the target.

If the identifier is found, the search continues by the context in this section.

If the context is found, the search is considered successful, and the system moves on to the next target.

If the context is not found, the source is then sought in the entire identified section.

If the source is found in this section, this source and optional other sources that are indicated in the section are stored.

If no corresponding source is found in the section, a search for this source is made in the entire file.

If no source is found in the file, the entirety of the definition of the target and its attributes is then excluded (by suppressing or ignoring it) in the model file.

If one (or more sources) is found in the source file, it is stored for carrying out a subsequent individual processing.

This processing can consist of an intervention by a user who inspects all the targets where an error was noted, obtains on the part of the device all the corresponding possible sources (obtained according to the above-mentioned process) and makes the choice of one of his sources in correspondence with the target.

Once this source is selected, the model file is amended with the corresponding attributes.

These steps of possible revision and correction of the targets can be implemented with other types of definitions of targets and other types of operations for replacement of targets by substitutes in the file.

They can therefore be implemented independently.

1. Process for adaptation of digital files consisting in referencing so-called source character strings in a file to be adapted, a so-called source file, and in replacing the sources by substitution data called substitutes, characterized by the fact that each source presence is referenced in the source file by defining a target by:
1° division of the source file into sections identified by a section identifier (ID);
2° selection of a source in a section;
3° selection of a context zone including the selected source;
4° assignment of an occurrence rank, in a predetermined portion of the source file, to the selected source;
the section identifier (ID), the selected source and its occurrence rank, whereby the selected context zone constitutes attributes of each target.

2. Process according to claim 1, wherein the predetermined portion of the source file is the selected context zone and wherein an occurrence rank, in the section, is assigned to the selected context zone.

3. Process according to claim 1, wherein a unique identifier (GUID) is associated with each defined target, and the definition attributes of the targets and the identifiers are stored in a model file.

4. Process according to claim 3, wherein at least one set of substitution data that contains the substitutes of the sources is created, and the targets and the substitutes are associated by the identifier (GUID).

5. Process according to claim 4, wherein the sources of the source file are replaced by:
1° location of each target by calculation of its position in the source file;
2° loading of a set of substitution data;
3° extraction of substitutes for the set of substitution data by
running through the substitutes and, for each, searching for the associated target,
storage of substitutes for which an associated target exists by classifying them by positional order of the associated target in the source file.

6. Process according to claim 5, wherein
Several sets of substitution data are used;
A priority order is assigned to each set of substitution data;
Steps of loading the set of substitution data and extracting substitutes successively for each set of substitution data by decreasing order of priority are carried out.

7. Process according to claim 5, wherein the targets are replaced by their substitutes by decreasing order of position in the source file.

8. Process according to claim 1, wherein the precision of the definition of targets of a source file is verified by:
comparison, for each target, of its attributes with the contents of the source file,
exclusion of targets for which no source corresponding to the source attribute of the target was found in the source file;
if at least one source corresponding to the source attribute of the target is found without the other attributes of the target corresponding to it, said source is stored for subsequent individual processing.

9. Process according to claim 2, wherein a unique identifier (GUID) is associated with each defined target, and the definition attributes of the targets and the identifiers are stored in a model file.

10. Process according to claim 6, wherein the targets are replaced by their substitutes by decreasing order of position in the source file.
